(19) United States
(12) Patent Application Publication
(10) Pub. No.: US 2025/0053831 A1
(43) Pub. Date: Feb. 13, 2025

(54) ARTIFICIAL INTELLIGENCE-BASED METHODS AND SYSTEMS FOR GENERATING ACCOUNT-RELATED SUMMARIES

(71) Applicant: MASTERCARD INTERNATIONAL INCORPORATED, PURCHASE, NY (US)

(72) Inventors: Ram Ganesh V, Ernakulam (IN); Harika Chintapeta Murali, Tirupati (IN); Debasmita Das, Kolkata (IN); Ankur Saraswat, Gurgaon (IN); Surbhi Malhotra, Pune (IN); Karen M. Griffin, White Plains, NY (US); Mateo Arbelaez, Southbury, CT (US); Joseph Kaczorowski, Kingston, NY (US)

(21) Appl. No.: 18/448,877

(22) Filed: Aug. 11, 2023

(51) Int. Cl. G06N 5/022; G06Q 20/40

(52) U.S. Cl. CPC G06N 5/022; G06Q 20/405

(57) ABSTRACT

Embodiments provide artificial intelligence based methods and systems for generating account-related summaries. Method performed by server system include accessing rule generator file and historical transaction data corresponding from database. The method includes generating a set of transaction features based on the rule generator file. The method includes extracting via a first machine learning model, a subset of relevant transaction features from the set of transaction features based on the historical transaction data. The method includes generating via second machine learning, a structured report template based on the subset of relevant transaction features. The structured template report includes a plurality of natural language sentences embedded with the subset of relevant transaction features. The method includes generating an account-related summary for the account holder by substituting each of the subset of relevant transaction features embedded in the plurality of natural language sentences with a corresponding feature value from the historical transaction data.

### TECHNICAL FIELD

The present disclosure relates to artificial intelligence-based processing systems in payment ecosystems and, more particularly to generating payment account-related summaries using learning techniques for various entities (such as acquirers or issuers).

### BACKGROUND

Issuing banks, commonly known as issuers, provide payment instruments such as payment cards (credit cards, debit cards, etc.) to users known as account holders or cardholders. As the number of account holders increases for each issuing bank, it becomes challenging for an issuing bank to manage and control the risks associated with payment transactions, especially with international payment transactions. The term ‘international payment transaction’ refers to a payment transaction between two or more associated enterprises, where at least one of the parties is a non-resident of the account holder's country of origin. Various examples of international payment transactions can include the purchase, sale, or lease of tangible or intangible property, lending or borrowing of assets, or any other transaction that may have an impact on the profits, income, losses, or assets of the concerned enterprise. It has been determined through research that international transactions are very susceptible to suspicious activities. For example, an account holder may try to conceal criminal activities and suspicious behavior ranging from small-time tax evasion and drug trafficking to public corruption and financing groups designated as terrorist organizations. Due to the involvement of different banks in an international transaction where each bank follows different fraud/money laundering mitigation practices and operates in different legal jurisdictions, it becomes very complicated to detect such suspicious activities. To avoid or mitigate such suspicious behavior, various anti-money laundering techniques have been developed. The term ‘Anti-money laundering’ refers to a web of laws, regulations, and procedures that aim to uncover efforts to disguise illicit payment transactions as licit. For example, an anti-money laundering technique can be used to detect a suspicious account holder that is declaring his illicit funds as legitimate income (i.e., funds that are an outcome of a money laundering activity).

One such anti-money laundering technique includes generating and submitting an anti-money laundering (AML) report by a financial institution such as a payment processor or an issuing bank to a national law enforcement body of the concerned country. This AML report and other reports pertaining to an account holder's account are known as account-related reports. These account-related reports provide key insights related to the account activities associated with the concerned account. It is understood that to generate the AML report, it is necessary to continuously monitor the accounts associated with the account holders to identify and report conduct any suspicious activities such as suspicious payment transactions performed by the account holder. In one example, such reports are prepared based on the internal rules and policies of the issuing bank or payment processor. In other words, account holders are flagged as suspicious of potentially being involved in suspicious activities or depicting suspicious behavior based on the internal rules and policies. For example, payment transactions above a certain threshold made by a single customer (i.e., the account holder) during a business day or without any apparent business purpose may be flagged as suspicious of being an attempt at money laundering by the account holder.

Generally, AML reports cite evidence, and facts pertaining to any suspicious activities performed by the account holder. One such evidence is an account-related summary that provides concise insights into the various activities due to which an account was flagged. In an example, the AML reports may be suspicious transaction reports (STRs) and suspicious activity reports (SARs). These reports may then be shared with the national law enforcement body for further action. For example, upon receiving the AML report, the national law enforcement body may direct the issuing bank of the account holder to freeze the digital assets of the suspicious account holder thereby, mitigating further suspicious activities. Conventionally, these AML reports including the account-related summaries are prepared manually by an analyst or a dedicated team of analysts which is a labor-intensive and time taking process. Such manually generated reports lead to delayed action from the national law enforcement body which leads to missed opportunities.

To eliminate this manual approach, various artificial intelligence-based approaches have been developed. Such approaches aim to automatically generate the account-related summaries for the flagged account holder included in these AML reports. One such approach includes using a Natural Language Processing (NLP) model to generate descriptive text based on structured or tabular transaction data. For example, an NLP model such as Generative Pre-trained Transformer can be used to generate account-related summaries. However, experimentally it has been determined that the existing artificial intelligence-based approaches are unable to process the understanding of contextual information and these existing models are prone to factual hallucination. Further, the existing approaches fail to accurately present information such as date of transaction, number of transactions, amount of transaction, and the like in the account-related summaries thus, generated.

Hence, there exists a technological need for more efficient methods and systems that can address the above-mentioned technical problems and generate account-related summaries that are precise, well-structured, logically correct, and free from any factual hallucination.

### SUMMARY

Various embodiments of the present disclosure provide methods and systems for generating an account-related summary corresponding to an account holder.

In an embodiment, a computer-implemented method for generating an account-related summary corresponding to an account holder is disclosed. The computer-implemented method performed by a server system includes accessing a rule generator file and historical transaction data corresponding to an account holder from a database associated with the server system. Further, the method includes generating a set of transaction features based, at least in part, on the rule generator file. Further, the method includes extracting via a first machine learning model, a subset of relevant transaction features from the set of transaction features based, at least in part, on the historical transaction data. Further, the method includes generating via a second machine learning model, a structured report template based, at least in part, on the subset of relevant transaction features. The structured template report includes a plurality of natural language sentences embedded with the subset of relevant transaction features. Further, the method includes generating an account-related summary for the account holder by substituting each of the subset of relevant transaction features embedded in the plurality of natural language sentences with a corresponding feature value from the historical transaction data.

In another embodiment, a server system is disclosed. The server system includes a communication interface and a memory including executable instructions. The server system also includes a processor communicably coupled to the memory. The processor is configured to execute the instructions to cause the server system, at least in part, to access a rule generator file and historical transaction data corresponding to an account holder from a database associated with the server system. Further, the system is caused to generate a set of transaction features based, at least in part, on the rule generator file. Further, the system is caused to extract via a first machine learning model, a subset of relevant transaction features from the set of transaction features based, at least in part, on the historical transaction data. Further, the system is caused to generate via a second machine learning model, a structured report template based, at least in part, on the subset of relevant transaction features. The structured template report includes a plurality of natural language sentences embedded with the subset of relevant transaction features. Further, the system is caused to generate an account-related summary for the account holder by substituting each of the subset of relevant transaction features embedded in the plurality of natural language sentences with a corresponding feature value from the historical transaction data.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a rule generator file and historical transaction data corresponding to an account holder from a database associated with the server system. Further, the method includes generating a set of transaction features based, at least in part, on the rule generator file. Further, the method includes extracting via a first machine learning model, a subset of relevant transaction features from the set of transaction features based, at least in part, on the historical transaction data. Further, the method includes generating via second machine learning, a structured report template based, at least in part, on the subset of relevant transaction features. The structured template report includes a plurality of natural language sentences embedded with the subset of relevant transaction features. Further, the method includes generating an account-related summary for the account holder by substituting each of the subset of relevant transaction features embedded in the plurality of natural language sentences with a corresponding feature value from the historical transaction data.

### BRIEF DESCRIPTION OF THE FIGURES

For a more complete understanding of example embodiments of the present technology, reference is now made to the following descriptions taken in connection with the accompanying drawings in which.

FIG. 1 illustrates an exemplary representation of an environment related to at least some embodiments of the present disclosure;

FIG. 2 is a simplified block diagram of a server system, in accordance with an embodiment of the present disclosure:

FIGS. 3A, 3B, and 3C, collectively, illustrate a simplified block diagram for generating account-related reports by the server system, in accordance with an embodiment of the present disclosure:

FIG. 4 illustrates a simplified example representation of an account-related summary generated by an analyst (i.e., a human) and a conventional machine learning model, in accordance with an embodiment of the present disclosure;

FIG. 5 illustrates a simplified example representation of an account-related summary generated by the analyst (i.e., a human) and the server system, in accordance with an example embodiment of the present disclosure:

FIG. 6 illustrates a method for generating account-related summary for an account holder, in accordance with an embodiment of the present disclosure.

FIG. 7 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, system, method, or computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a “circuit,” “engine” “module” or “system.” Furthermore, aspects of the present disclosure may take the form of a computer program product embodied in one or more computer-readable storage media having computer-readable program code embodied thereon.

The term “payment account” used throughout the description refers to a financial account that is used to fund a financial transaction (interchangeably referred to as “card-on-file payment transaction”). Examples of financial accounts include, but are not limited to, a savings account, a credit account, a checking account, and a virtual payment account. The financial account may be associated with an entity (known as an account holder) such as an individual person, a family, a commercial entity, a company, a corporation, a governmental entity, a non-profit organization, and the like. In some scenarios, a financial account may be a virtual or temporary payment account that can be mapped or linked to a primary financial account, such as those accounts managed by payment wallet service providers, and the like.

The term ‘account holder’ refers to used throughout the description refers to an owner of the payment account. Examples of the account holder include a customer of the issuing bank that has either a savings account, a credit account, a checking account, or a virtual payment account with the issuing bank. In some scenarios, the account holder may be issued a payment card (such as a credit card, debit card, or the like) by the issuing bank. Upon being issued the payment card, the account holder can also be called a cardholder. To that end, the term “cardholder” as used throughout the description, and refers to a person (i.e., the account holder) who holds a credit or a debit card that will be used by a merchant to perform a card-on-file payment transaction. It should be noted that the terms account holder and cardholder are used interchangeably throughout the description for the purposes of explanation however, the account holder doesn't necessarily have to be a cardholder.

The term “payment network”, used herein, refers to a network or collection of systems used for the transfer of funds through the use of cash-substitutes. Payment networks may use a variety of different protocols and procedures in order to process the transfer of money for various types of transactions. Transactions that may be performed via a payment network may include goods or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by such as Mastercard®.

The term “merchant”, used throughout the description generally refers to a seller, a retailer, a purchase location, an organization, or any other entity that is in the business of selling goods or providing services, and it can refer to either a single business location or a chain of business locations of the same entity.

### Overview

Various embodiments of the present disclosure provide methods, systems, user devices, and computer program products for generating an account-related summary corresponding to an account holder.

In an embodiment, a server system is configured to access a rule generator file and historical transaction data corresponding to an account holder from a database associated with the server system. In an example, the server system is a payment server associated with a payment network. In various examples, the historical transaction data includes transaction-related information. Herein, the transaction-related information includes at least a date of a payment transaction, an amount of payment transaction, and a number of domestic/international transactions that took place in the past 3/6/12 months with the same or different merchants, and Merchant Category Codes (MCCs). Further, in an embodiment, the rule generator file is generated by the server system based, at least in part, on one or more alerts. It is noted that the rule generator file includes a plurality of data fields. In various examples, the plurality of data fields includes at least alert time, alert month, alert day, alert rule, transaction identifier (ID), issuer name, acquirer name, alert driver, and account-related summary. In another embodiment, the server system is configured to generate the one or more alerts corresponding to one or more transactions performed by the account holder based, at least in part, on the historical transaction data and a plurality of predefined rules. In an example, each of the one or more alerts corresponds to a reason for triggering an alert.

In another embodiment, the server system is configured to extract via a first machine learning model, a subset of relevant transaction features from the set of transaction features based, at least in part, on the historical transaction data. In one implementation, the first machine-learning model is a meta-learning model.

In another embodiment, the server system is configured to generate via a second machine learning model, a structured report template based, at least in part, on the subset of relevant transaction features. Herein, the structured template report includes a plurality of natural language sentences embedded with the subset of relevant transaction features. In one implementation, the second machine-learning model is a language model.

In another embodiment, the server system is configured to generate an account-related summary for the account holder by substituting each of the subset of relevant transaction features embedded in the plurality of natural language sentences with a corresponding feature value from the historical transaction data. In order to substitute each of the subset of relevant transaction features, the server system is further configured to at first, determine one or more corresponding feature values of each of the subset of relevant transaction features embedded in the plurality of natural language sentences based, at least in part, on extracting transaction-related information from the historical transaction data. Then, the server system is configured to compute the corresponding feature value based, at least in part, on the extracted transaction-related information.

In another embodiment, the server system is configured to generate an account-related report by populating the account-related summary field of the rule generator file with the account-related summary for the account holder. Further, the server system is configured to transmit the account-related report to an external server such as a plurality of issuers/acquirers or regulatory bodies.

Various embodiments of the present disclosure provide multiple advantages and technical effects while addressing technical problems such as how to automatically generate factually correct account-related summaries and the like. To that end, the various embodiments of the present disclosure provide an approach for automatically generating the account-related summaries among other technical effects. For instance, the account-related summary generated by the server system reduces the time required to generate the account-related summaries when compared with an analyst or team of analysts. Thus, improving reaction and reporting time while also saving financial resources. Further, issues related to other machine learning based approaches for generating such summaries including factual hallucination are also eliminated by relying on the meta-learning based approach of the present disclosure. Further, it is noted that since the subset of relevant transaction features are not directly processed but are replaced within the natural language sentences, their integrity is ensured. This aspect reduces the overall errors within the final summary while also saving processing resources. It is noted that these resources are saved since the subset of relevant transaction features is not directly processed.

Various embodiments of the present disclosure provide methods, systems electronic devices, and computer program products for generating an account-related summary corresponding to an account holder. The account-related summary can be used to generate an account-related report that can be shared with an enforcing entity such as a national law enforcement body or any other entity to determine or describe the account holder's behavior. To that end, the present disclosure provides an approach for generating the account-related summary associated with the account holder by leveraging artificial intelligence models.

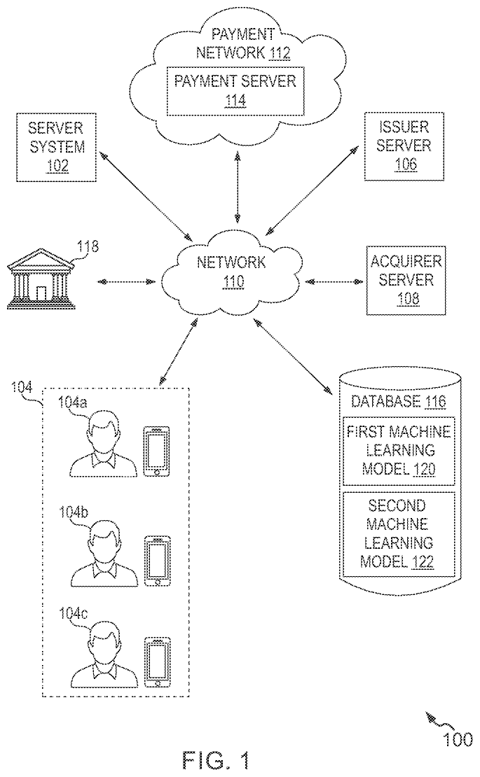

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, the account-related summary to be generated, an account-related report to be generated, etc. The environment 100 generally includes a plurality of entities, for example, a server system 102, a plurality of account holders 104 (including account holder 104a, account holder 104b, and account holder 104c) associated with a plurality of electronic devices, an issuer server 106, an acquirer server 108, a payment network 112 including a payment server 114, a database 116, a merchant 118 each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof. The plurality of account holders 104 hereinafter is collectively referred to as “account holder 104” for ease of description.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. For example, the network 110 may include multiple different networks, such as a private network made accessible by the payment network 112 to the issuer server 106, the acquirer server 108, and the payment server 114, separately, and a public network (e.g., the Internet, etc.).

In an embodiment, the issuer server 106 is a computing server that is associated with an issuer bank of the account holder 104. The issuer bank is a financial institution that manages the accounts of multiple account holders. Account details of the accounts established with the issuer bank are stored in account holder profiles of the account holder in a memory of the issuer server 106 or on a cloud server associated with the issuer server 106. The issuer server 106 is responsible for approving or denying any request associated with a payment transaction such as a payment authorization request. The terms “issuer”, “issuer bank”, “issuing bank” or “issuer server” are used interchangeably herein for the sake of description.

In an embodiment, the acquirer server 108 is a computing server that is associated with an acquirer bank of any merchant such as the merchant 118. The acquirer bank is a financial institution (e.g., a bank) that processes financial transactions. This can be an institution that facilitates the processing of payment transactions for physical stores, ATM terminals, merchants, or an institution that owns platforms that make online purchases or purchases made via software applications possible (e.g., shopping cart platform providers and in-app payment processing providers). The terms “acquirer”, “acquirer bank”, “acquiring bank” or “acquirer server” will be used interchangeably herein for the sake of description.

In an embodiment, the payment server 114 is a computing server that is associated with a payment processing financial institution (e.g., Mastercard®) that facilitates the communication between the issuer 106 and the acquirer 108. Various messages and requests are exchanged between the issuer 106 and the acquirer 108 through the payment server 114. For example, the issuer 106 routes an authorization response message to the acquirer 108 via the payment network 112 through the payment server 114.

In one non-limiting example, the processes ranging from initiation to completion of payment transactions via various financial instruments or tools such as wire-transfer, electronic transfer, payment cards, and the like are facilitated by a combination of the issuer server 106, the payment server 114, and the acquirer server 108. In one embodiment, a payment transaction request is sent to the payment server 114 associated with the payment network 112 by the merchant 118 (e.g., payment terminal associated with the merchant 108 or online payment transaction request) using the network 110.

In an exemplary scenario, the account holder 104 purchases goods or services from the merchant 118 using a payment card by performing a Card Present (CP) transaction at a payment terminal associated with the merchant 118. Examples of the merchant 108 may include any retail shop, restaurant, supermarket or establishment, government and/or private agencies, or any such place equipped with payment terminals, such as point-of-sale (POS) devices where customers, i.e., account holders visit for performing the financial transaction in exchange for any goods and/or services or any transaction that requires financial transaction between the account holder 104 and the merchant 108.

In another example scenario, the account holder 104 performs a wire-transfer of funds to another account holder, the merchant 118, or any other recipient. The term ‘wire-transfer’ refers to an electronic method for transferring funds between two different banks by an account holder (such as the account holder 104). To perform the wire-transfer, the account holder 104 may use their electronic device (such as a smart phone) to access their banking account on a webpage associated with the issuer bank 106 (i.e., payment facilitator page). In various examples, the account holder 104 can perform fund transfers using third-party websites, applications, e-wallets, and the like. In various non-limiting examples, electronic devices may include, but are not limited to, a smartphone, a tablet, a laptop, a computer system, a personal digital assistant (PDA), and the like.

To complete the payment/funds transfer, the account holder 104 in one scenario may enter corresponding details related to the payment such as, but not limited to, payment card details presented on the payment card, account details of the account holder 104, account details of the merchant 118, account details of another account holder, information related to the payment (such as payment amount, number of debits which determine the time period of payments (in case of PreAuth transactions), payment frequency, and the like.

It should be understood that the account holder 104 may be involved in criminal activities and suspicious behavior ranging from money laundering, tax evasion, and drug trafficking to public corruption and financing terror groups. As per government regulations, such suspicious account holders along with the corresponding evidence have to be reported to enforcing authorities. The enforcing authorities may undertake their investigations to determine the validity of the accusation laid against the account holder. One example of the law enforcing authority is the Financial Intelligence Unit under the Department of Revenue, India. Upon determining that the account holder is guilty, he or she may be punished or sanctioned accordingly by law: One such method of sharing evidence with the enforcing authorities is via account-related reports. An account-related report includes the account-related summary along with other information that summarizes the financial activity of an account holder (such as the account holder 104) and flags any suspicious financial activity such as illicit purchase, sale, or transfer of funds by the account holder 104. Examples of account-related reports include suspicious transaction reports (STRs), suspicious activity reports (SARs), and the like. Generally, the account-related summaries and reports are generated by an analyst, a team of analysts, or a dedicated taskforce which is a time-consuming and complex process. Further, there is no margin for error while generating such reports since they have to be used as evidence by the enforcing authorities. However, since the conventional process is manual in nature thus, there exists a possibility of human error which has to be eliminated.

To address the above-mentioned technical problem among other problems, the server system 102 is provided by the present disclosure that is configured to perform one or more of the operations described herein. In one non-limiting example, the server system 102 is embodied in the payment server 114. In some scenarios, the server system 102 is a separate part of the environment 100 and may operate apart from (but still in communication with, for example, via the network 110), the issuer server 106, the acquirer server 108, the payment server 114, and any third-party external servers (to access data to perform the various operations described herein). However, in other embodiments, the server system 102 may actually be incorporated, in whole or in part, into one or more parts of the environment 100, for example, the payment server 114. In addition, the server system 102 should be understood to be embodied in at least one computing device in communication with the network 110, which may be specifically configured, via executable instructions, to perform as described herein, and/or embodied in at least one non-transitory computer-readable media.

In an embodiment, the server system 102 is configured to track or monitor the financial activity of the account holder 104 associated with the issuer 106. In particular, each and every payment transaction performed by the account holder 104 with any merchant, another account holder, or any entity is tracked. Then, the financial activity in the form of transaction-related information is stored as historical transaction data in the database 116 associated with the server system 102. In a non-limiting example, historical transaction data as a tabular dataset. The term “tabular dataset” refers to a collection of related sets of information (herein, transaction-related information of the account holder 104) that can be composed of different elements represented in tabular form but can be manipulated as a unit by a computer. In some embodiments, a dataset can include a plurality of feature vectors. In a non-limiting example, the transaction-related information includes, but is not limited to, a transaction identifier (ID), a merchant name, merchant identifier (ID), a merchant category code (MCC), a cross-border transaction flag, a payment card type (debit/credit/prepaid), a card product type, a transaction channel (e.g., e-commerce, recurring, etc.), a card-not-present (CNP) transaction flag, a response code flag (approve/decline), a decline reason code (in case of a declined transaction), a credit score, receiver's account details, receiver's issuer ID, and the like.

In another embodiment, the server system 102 is configured to determine whether the account holder 104 is involved in suspicious or criminal activity based on the monitored account holder activity, i.e., the historical transaction data. In various non-limiting examples, historical transaction data of the account holder 104 may be analyzed to determine whether the account holder 104 is involved in any suspicious activity. In other scenarios, the server system 102 is configured to evaluate and track every transaction performed by the account holder 104 within the payment network 112 using internal and external data to detect suspicious activities such as money laundering risk using a set of dynamic rules and/or predictive models. Further, upon determining that the account holder 104 is involved in suspicious/fraudulent/criminal, the server system 102 is configured to generate the account-related summary including evidence of the suspicious behavior of the account holder 104. Thereafter, the server system 102 is configured to generate the account-related report based on the account-related summary. Furthermore, the server system 102 is configured to transmit or submit the account-related report to the enforcement authorities or any other concerned entity as per the country's regulations. Additionally, it that is understood fraudulent/criminal/suspicious as mentioned herein refers to illicit activities such as, but not limited to, suspicious or unauthorized transactions, lost or stolen merchandise, false requests for a refund, return or bounced checks, money laundering, funds transfer to accounts previously flagged as belonging to criminal or terrorist organizations and the like.

In an embodiment, the server system 102 is configured to utilize hardware-run Artificial Intelligence (AI) or Machine Learning (ML) models and/or statistical ordinal regression techniques for generating the account-related summaries and the account-related reports. In a non-limiting example, the server system 102 utilizes a first machine learning model 120 and a second machine learning model 122 stored in the database 116 to generate the account-related summary. This aspect of the present disclosure is explained later. It is noted that generating the account-related summaries and the account-related reports describe the suspicious activities or behavior of an account holder 104 that may be engaged in an illegal or prohibited activity but does not confirm the same. Rather, the account-related summaries and the account-related reports provide the necessary basis for confirming by an analysts/investigators or investigation specific machine learning models to confirm whether such illegal or prohibited activity has been performed.

In an embodiment, the database 116 is a central repository for storing data including the historical transaction data, the various machine learning models including the first machine learning model 120 and the second machine leaning model 122, machine-readable instructions, and algorithms for operating the server system 102. In various implementations, the database 116 can be embodied within the server system 102, as a part of the server system 102, or as an independent entity that is communicably coupled with the server system 102 via the network 110.

In various non-limiting examples, the database 116 may include one or more hard disk drives (HDD), solid-state drives (SSD), an Advanced Technology Attachment (ATA) adapter, a Serial ATA (SATA) adapter, a Small Computer System Interface (SCSI) adapter, a redundant array of independent disks (RAID) controller, a storage area network (SAN) adapter, a network adapter, and/or any component providing the server system 102 with access to the database 116. In one implementation, the database 120 may be viewed, accessed, amended, updated, and/or deleted by an administrator (not shown) associated with the server system 102 through a database management system (DBMS) or relational database management system (RDBMS) present within the database 116.

In one embodiment, the payment network 112 may be used by the payment card issuing authorities as a payment interchange network. The payment network 112 may include a plurality of payment servers such as the payment server 114. Examples of payment interchange networks include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks: different systems, devices, and/or networks; and/or differently arranged systems, devices, and/or networks than those shown in FIG. 1. Furthermore, two or more systems or devices shown in FIG. 1 may be implemented within a single system or device, or a single system or device as shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

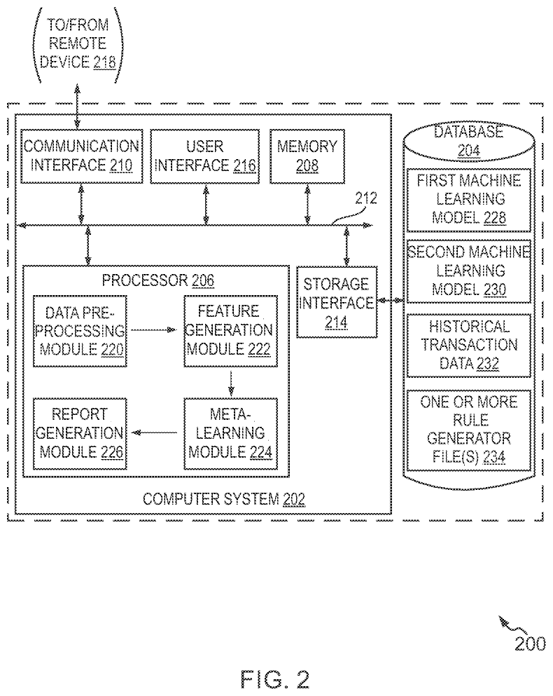

FIG. 2 is a simplified block diagram of a server system 200, in accordance with an embodiment of the present disclosure. The server system 200 is identical to the server system 102 of FIG. 1. In one embodiment, the server system 200 is a part of the payment server 114. In some embodiments, the server system 200 is embodied as a cloud-based and/or SaaS-based (software as a service) architecture. The server system 200 includes a computer system 202 and a database 204. The computer system 202 includes at least one processor 206 for executing instructions, a memory 208, a communication interface 210, a storage interface 214, and a user interface 216 that communicate with each other via a bus 212.

In some embodiments, the database 204 is integrated within the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one implementation, the database 204 is configured to store a first machine learning model 228, a second machine learning model 230 similar to the first machine learning model 120, and the second machine learning 122 of FIG. 1. Further, the database 204 is configured to store the historical transaction data 232 and one or more rule generator file(s) 234.

In an embodiment, the first machine learning model 228 is a meta-learning model. It is understood that a meta-learning model is a learning algorithm that learns from the learning of other learning algorithms. Essentially, meta-learning models are used to learn how to best combine the predictions from other machine learning algorithms in the field of ensemble learning. In another embodiment, the second machine learning model 230 is a language model that is configured to utilize various statistical and probabilistic techniques to determine the probability of a given sequence of words occurring in a sentence. The second machine learning model 230 uses a natural language generation function to generate automatic text by using the table-to-text generation (TTG) model. In a non-limiting example, the second machine learning model 230 is a transformer based model. It is understood that any language model can achieve knowledge transfer by utilizing the table-to-text downstream task.

In an embodiment, the historical transaction data 232 refers to transaction-related information corresponding to a plurality of historical transactions performed by an account holder (such as the account holder 104). The explanation for the historical transaction data 232 has also been provided with reference to the description of FIG. 1, therefore the same is not repeated again for the sake of brevity. In another embodiment, the one or more rule generator file(s) 234 refers to an executive file generated by a suspicious transaction detection model operated by the payment server 112, the issuer server 106, or the acquirer server 108. In an example, the suspicious transaction detection model is configured to generate one or more alerts corresponding to one or more transactions performed by the account holder 104 based on one or more rules. The alerts correspond to one or more likely-criminal or suspicious activities conducted by the account holder 104 that have been flagged by the suspicious transaction detection model. In one example, the suspicious transaction detection model can be an AI or ML model trained based on historical transaction data and a plurality of predefined rules for identifying likely-criminal or suspicious behavior of the account holder 104. In various non-limiting examples, the one or more rules may be predetermined by a payment processor based on an internal risk assessment policy. The term ‘one or more rule generator file(s) 234’ is referred hereinafter to as ‘rule generator file 234’ for ease of description. In a non-liming example, both the historical transaction data 232 and the rule generator file 234 are tabular datasets. In various examples, the rule generator file 234 includes a plurality of fields such as, but not limited to, alert time, alert month, alert day, alert rule, transaction ID, issuer name, acquirer name, alert driver, account-related summary and the like.

In various non-limiting examples, the one or more rules may include (a) excessive transactions by foreign issued cards with merchants susceptible to money laundering (such as Jewelry stores, Art dealers, and the like) in high risk locations, (b) repetitive transactions by card issued in a high risk country used at the same merchant in high risk locations, (c) excessive card usage by card issued abroad in high risk countries used in high risk locations for a long period of time, (d) repeated usage of card issued abroad in high risk country used in high risk locations to withdraw cash during night hours, (e) recurring and excessive cash ATM withdrawals by card issued abroad in high risk country used at any ATM location, (f) recurring cash withdrawals using card issued abroad in high risk locations, (g) high value transactions using card issued in a high risk country, and the like.

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210 such that the processor 206 is capable of communicating with a remote device 218 such as a server associated with a law enforcing body, or communicated with any entity connected to the network 110 (as shown in FIG. 1). Further, the processor 206 is operatively coupled to the user interface 216 for performing one or more embodiments described herein.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a data pre-processing module 220, a feature generation module 222, a meta-learning module 224, and a report generation module 226. It should be noted that components, described herein, such as the data pre-processing module 220, the feature generation module 222, the meta-learning module 224, and the report generation module 226 can be configured in a variety of configurations, including electronic circuitries, digital arithmetic, and logic blocks, and memory systems in combination with software, firmware, and embedded technologies. Further, it is noted that the components of the processor 206 are communicably coupled with each other and are configured to transmit and receive to/from each other. In one implementation, the processor 206 is configured to run or execute an algorithm (stored in the database 204) to generate an account-related summary indicating a narrative summary of likely criminal/suspicious transactions performed by the account holder 104.

In an embodiment, the data pre-processing module 220 includes suitable logic and/or interfaces for accessing historical transaction data 232 associated with the account holder from the database 204. In various examples, the historical transaction data 232 includes at least transaction-related information/attributes such as the date of a payment transaction, an amount of payment transaction, and a number of domestic/international transactions that took place in the past 3/6/12 months with the same or different merchants, Merchant category codes (MCCs), and the like. In an example, the historical transaction data 232 represents transactions performed by the account holder 104 across various merchant categories such as grocery, restaurant, jewelry store, airlines, and the like. In another example, the historical transaction data 232 represents transactions performed by the account holder 104 across various merchant industries such as retail clothing, hotel industry, and the like. In yet another example, the historical transaction data represents transactions performed by the account holders 232 across various locations where the transactions took place, and payment transaction types such as contactless, card-present, and the like.

Further, the data pre-processing module 220 is configured to determine a suspicious transaction likelihood by the account holder 104 based, at least in part, on the historical transaction data 232. In a non-limiting example, various AI or ML models including, but not limited to, a suspicious transaction detection model can be utilized by the data pre-processing module 220 to determine the likelihood of a transaction performed by the account holder 104 of being involved in a fraudulent/suspicious/criminal activity based at least on analyzing the historical transaction data 232. In particular, the suspicious transaction detection model is configured to generate one or more alerts corresponding to one or more transactions performed by the account holder 104 based, at least in part, on a plurality of predefined rules. The alerts correspond to one or more suspicious activities performed by the account holder 104 that have been flagged by the suspicious transaction detection model. For example, high-value funds transfer through wire-transfer to different countries within a short duration of time can be flagged as suspicious activity, and therefore, an alert is generated for the same. It is understood that apart from the data pre-processing module 220, the suspicious transaction detection model may be operated by the payment server 112, the issuer server 106, or the acquirer server 108. In this scenario, the data pre-processing module 220 is configured to receive the one or more alerts corresponding to one or more transactions that are generated by the suspicious transaction detection model from the payment server 112, the issuer server 106, or the acquirer server 108.

In another embodiment, the data pre-processing module 220 is configured to generate a rule generator file (such as the rule generator file 234) based, at least in part, on the one or more alerts. In various examples, the rule generator file 234 includes a plurality of data fields such as, but not limited to, alert time, alert month, alert day, alert rule, transaction ID, issuer name, acquirer name, alert driver, and the like. In an embodiment, the rule generator file 234 includes an empty data field for an account-related summary that can be populated with account-related summary of the account holder 104 to generate an account-related report. The explanation for generating an account-related report by populating the empty data field for an account-related summary is described later in the present disclosure. In some implementations, the data pre-processing module 220 is configured to perform operations (such as data-cleaning, normalization, feature extraction, and the like) on the historical transaction data 232 of the account holder 104. In another embodiment, the data pre-processing module 220 is configured to transmit the rule generator file 234 to the feature generation module 222.

In an embodiments, the feature generation module 222 includes suitable logic and/or interfaces for generating, a set of transaction features based, at least in part, on the rule generator file 234. In particular, the plurality of data fields of the rule generator file 234 are analyzed to determine the alert rule triggered for the corresponding transactions of the account holder 104. More specifically, each alert rule is utilized by the feature generation module 222 to generate a transaction feature. It is understood that if for a given time duration, multiple transactions performed by the account holder 104 have been flagged within the rule generator file 234, then each of the flagged transactions will have a corresponding alert rule. The alert rule indicates a reason for triggering an alert. For example, high-volume ATM withdrawals within a day may be flagged by one alert rule. On the other hand, frequent international transactions to countries labeled as high risk for money laundering activities will be flagged by another rule.

In various examples, the set of transaction features may include at least transaction velocity features for automatic teller machine (ATM), Point of Sale (POS) devices, and electronic commerce-based payment transactions for the cardholders, spending patterns at merchant industries, and cross-border transaction patterns, location pattern data related to the payment transactions, list of all merchant names from the transactions took place in a given month, list of all national/international states where transactions took place, card product types (such as Standard, Platinum, etc.), and the like.

In a non-limiting example, the set of transaction features is shown in Table 1 given below:

| | Group | |
|---|---|---|
| Transaction features | name | Description |
| pan | | Card number |
| alert_trans | Alert- | Number of transactions that happened in a given |
| | related | month |
| alert_usd | information | A sum of transaction amounts in USD from the |
| | | transactions that happened in a given month |
| alert_mcc | | List of all MCCs from the transactions that |
| | | happened in a given month |
| alert_merch | | List of all merchant names from the transactions |
| | | that happened in a given month |
| alert_inr | | The sum of transaction amounts in INR from the |
| | | transactions that happened in a given month |
| india_state | | List of all Indian states where transactions |
| | | happened in a given month |
| dates | | List of Dates of transactions from the transactions |
| | | that happened in a given month |
| ch_presence | | Card holder presence during the triggered |
| | | transaction |
| odd5_txns | | The number of transactions that happened between |
| | | 12 am to 5 am in a given month |
| odd5_total inr | | The sum of amounts in INR of transactions |
| | | happened between 12 am to 5 am in a given month |
| odd5_total_usd | | The sum of amounts in USD of transactions |
| | | happened between 12 am to 5 am in a given month |
| odd12_txns | | The number of transactions that happened between |
| | | 5 pm to 12 pm in a given month |
| odd12_total_inr | | The sum of amounts in INR of transactions |
| | | happened between 5 am to 12 pm in a given month |
| odd12_total_usd | | The sum of amounts in USD of transactions |
| | | happened between 5 am to 12 pm in a given month |
| odd18_txns | | The number of transactions that happened between |
| | | 12 pm to 8 pm in a given month |
| odd18_total_inr | | The sum of amounts in INR of transactions |
| | | happened between 12 pm to 8 pm in a given month |
| odd18_total_usd | | The sum of amounts in USD of transactions |
| | | happened between 12 pm to 8 pm in a given month |
| odd24_txns | | Number of transactions that happened after 8 pm in |
| | | a given month |
| odd24_total_inr | | The sum of amounts in INR of transactions |
| | | happened after 8 pm in a given month |
| odd24_total_usd | | The sum of amounts in USD of transactions |
| | | happened after 8 pm in a given month |
| cnt_month_wds | | Count of withdrawals in the last month in a given |
| | | month |
| sum_month_wds_usd | | The sum of withdrawals in USD in a given month |
| sum_month_wds_inr | | The sum of withdrawals in INR in a given month |
| cnt_6month_wds | | Count of withdrawals in 6 months |
| sum_6month_ | | The sum of withdrawals in 6 months in USD |
| wds_usd | | |
| sum_6month_ | | The sum of withdrawals in 6 months in INR |
| wds_inr | | |
| min_wd_date | | Latest withdrawal date in 6 months |
| max_wd_date | | Earliest withdrawal date in 6 months |
| wd_months | | List of months when withdrawal has happened |
| rec_flag | | Recurring withdrawals indicator |
| n_rec | | A number of recurring withdrawals happened |
| hv_flag | | High-value transaction indicator |
| hv_amt_inr | | The sum of high-value transactions in INR that |
| | | happened in a given month |
| hv_amt_usd | | The sum of high-value transactions in USD that |
| | | happened in a given month |
| hv_txns | | Number of high-value transactions that happened |
| | | in a given month |
| hv_mcc_list | | List of MCCs of high-value transactions that |
| | | happened in a given month |
| hv_merch_names | | List of Merchant names of high-value transactions |
| | | that happened in a given month |
| hv_states | | List of Indian states where high-value transactions |
| | | happened in a given month |
| hv_dates | | List of dates when high-value transactions |
| | | happened in a given month |
| same_merch_ | Domestic | The number of transactions that happened in the |
| past_trans | transaction- | last 6 months with the same merchants as of the last |
| | related | month |
| diff_merch_ | information | A number of transactions happened in the last 6 |
| past_trans | | months with the different merchants that were not |
| | | there in the last month |
| mcc_same | | List of MCCs of transactions that happened in the |
| | | last 6 months with the same merchants as of the last |
| | | month |
| mcc_diff | | List of MCCs of transactions that happened in the |
| | | last 6 months with the different merchants as of the |
| | | last month |
| merch_same | | List of merchants from transactions that happened |
| | | in the last 6 months with the same merchants as of |
| | | the last month |
| merch_diff | | List of merchants from transactions that happened |
| | | in the last 6 months with the different merchants as |
| | | of the last month |
| usd_same_mcc | | The sum of transactions that happened in the last 6 |
| | | months with the same merchants as of the last |
| | | month in USD |
| usd_diff_mcc | | The sum of transactions that happened in the last 6 |
| | | months with the different merchants as of the last |
| | | month in USD |
| bal_enq_wds_ | | Balance inquiries and cash withdrawals in the last |
| 5months | | 6 months |
| cnt_wds_5months | | Count of cash withdrawals in last 6 months |
| sum_wds_5months | | The sum of cash withdrawals in the last 6 months |
| bal_enq_5months | | Count of balance inquiries in last 6 months |
| driver | Home | Alert driver |
| home | country- | Home country code |
| prod_name | related | Product name |
| prod_grp_name | information | Product Group Name |
| iss_country | | Issuer Country |
| cd_ind | | Credit/Debit Indicator |
| home_trans | | Number of transactions in Home country |
| home_usd | | The sum of transactions in the Home country in |
| | | USD |
| home_mcc | | List of MCCs from transactions in the home |
| | | country |
| home_merch | | List of Merchants from transactions in the home |
| | | country |
| oth_trans | Foreign | Number of transactions that happened in other |
| | country- | countries in 6 months |
| oth_usd | related | The sum of transactions that happened in other |
| | information | countries in 6 months in USD |
| oth_mcc | | List of MCCs belonging to transactions that |
| | | happened in other countries in 6 months |
| oth_merch | | List of merchant names belonging to transactions |
| | | that happened in other countries in 6 months |
| oth_cntry_list | | List of other countries |
| | | happened in 6 months |

In one implementation, the set of transaction features may be categorized into categorical features and numerical features. In addition, the categorical features can be converted into numerical features using one hot encoding. In general, one hot encoding is a data conversion technique used for the conversion of categorical features into numerical features. In another embodiment, the feature generation module 222 is configured to transmit the set of transaction features to the meta-learning module 224.

In an embodiment, the meta-learning module 224 includes suitable logic and/or interfaces for extracting a subset of relevant transaction features from the set of transaction features based, at least in part, on the historical transaction data 232. In particular, an AI or ML model may be used by the meta-learning module 224 to extract the subset of relevant transaction features from the set of transaction features. In a non-limiting example, the first machine learning model 228 is utilized by the meta-learning module 224 to extract the subset of relevant transaction features from the set of transaction features based, at least in part, on the historical transaction data 232. It is understood that the first machine learning model 228 is a hardware-run machine learning model. The meta-learning module 224 is configured to compare, via the first machine learning model 228, the set of transaction features with the historical transaction data 232 to determine a subset of transaction features that are relevant to the particular account holder 104. In particular, the first machine learning model 228 is trained to determine the relevance of transaction features for a particular account holder 104 by analyzing its historical transactions. For example, foreign country-related information based transaction features may not be deemed as relevant if the first machine learning model 228 determines based on analyzing the historical transaction data 232 of the account holder 104 that he/she frequently travels to different countries. In other words, the first machine learning model 228 learns the underlying relationship between the plurality of historical transactions performed by the account holder 104 stored in the historical transaction data 232 by analyzing the transaction-related information/attributes of the historical transaction data 232. It is noted that in a non-limiting example, there exists no individual relationship between the server system 200 and the account holders, rather it is the acquirers and issuers that have individual customer relationships with the account holders. Then, the first machine learning model 228 determines the subset of transaction features based on comparing the relevance of the transaction features with the learned relationship between the plurality of historical transactions. In a non-limiting example, the first machine learning model 228 is a meta-learning model.

It is understood that the set of transaction features includes “n” number of features, e.g., 60 to 70 transaction features. However, these transaction features are generic in nature and are not tuned to the behavior of the account holder 104 and thus, cannot be used to generate a narrative summary of the suspicious activity of the account holder 104. Therefore, relevant transaction features have to be sorted from the set of transaction features. Further, it is understood that extracting the subset of relevant transaction features improves the quality of the summary generated later on by ensuring that it is account specific and relevant to the behavior of a specific account holder 104. Furthermore, the summary thus generated will also be more concise, informative, and accurate. The aspect regarding extraction of a subset of relevant transaction features from the set of transaction features via a first machine learning model 228 is later explained in detail. In another embodiment, the meta-learning module 224 is configured to transmit the set of transaction features to the report generation module 226.

In an embodiment, the report generation module 226 includes suitable logic and/or interfaces for generating a structured report template based, at least in part, on the subset of relevant transaction features. The structured template report includes a plurality of natural language sentences embedded with the subset of relevant transaction features. In particular, an AI or ML model may be used by the report generation module 226 to generate the plurality of natural language sentences embedded with the subset of relevant transaction features. In a non-limiting example, the second machine learning model 230 is utilized by the report generation module 226 to generate the structured template report including a plurality of natural language sentences embedded with the subset of relevant transaction features. It is understood that the second machine learning model 230 is a hardware-run machine learning model. In a non-limiting example, the second machine learning model 230 is a language model. In one example, the second machine learning model 230 is an abstractive summarization model such as a Table-to-Text Transfer Transformer (T5) algorithm.

The report generation module 226 is configured to construct the plurality of natural language sentences based, at least in part, on the subset of relevant transaction features. It should be noted that the plurality of natural language sentences defines a contextual relationship between the subset of relevant transaction features. In particular, the structured report template is generated by the second machine learning model 230 by utilizing various statistical and probabilistic techniques to determine the probability of a given sequence of words occurring in a sentence alongside one or more of the subset of relevant transaction features.

In another embodiment, the report generation module 226 is configured to substitute each of the subsets of relevant transaction features embedded in the plurality of natural language sentences of the structured report template with a corresponding feature value from the historical transaction data to generate an account-related summary. In an example, if a relevant transaction feature ‘odd5_txns’ (indicating the Number of transactions happened between 12 am to 5 am in a given month see. Table 1) is embedded in one of the plurality of natural language sentences, then the same will be substituted with the actual number of transactions that took place between 12 am to 5 am in a month. Further, this actual number is derived from the historical transaction data 232. In some embodiments, the report generation module 226 is configured to determine the corresponding feature value of each of the subset of relevant transaction features embedded in the plurality of natural language sentences based, at least in part, on the historical transaction data 232. For example, if a relevant transaction feature ‘odd12_total_usd’ (indicating the Sum of amounts in USD of transactions that happened between 5 am to 12 pm in a given month see, Table 1) is embedded in one of the plurality of natural language sentences. Then, at first, USD values from the data fields corresponding to the transaction in USD for the defined time period will be extracted from the historical transaction data 232. Upon accessing the data, a sum of the USD values is computed and further, the sum is substituted with the ‘odd12_total_usd’ feature. In other words, at first, one or more corresponding feature values of each of the subset of relevant transaction features embedded in the plurality of natural language sentences are determined based, at least in part, on extracting transaction-related information from the historical transaction data. Thereafter, the corresponding feature value (i.e., the actual final value) is computed based, at least in part, on the extracted transaction-related information.

In another embodiment, the report generation module 226 is configured to generate an account-related report by populating the empty data field of the rule generator file 234 with the account-related summary. In another embodiment, the report generation module 226 is configured to transmit the account-related report to an external server, i.e., a server associated with the concerned law enforcement authority or body.

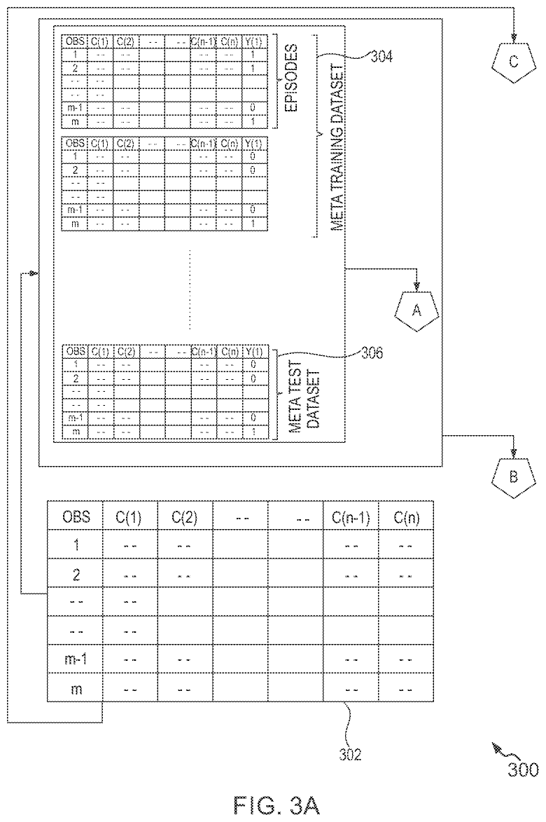

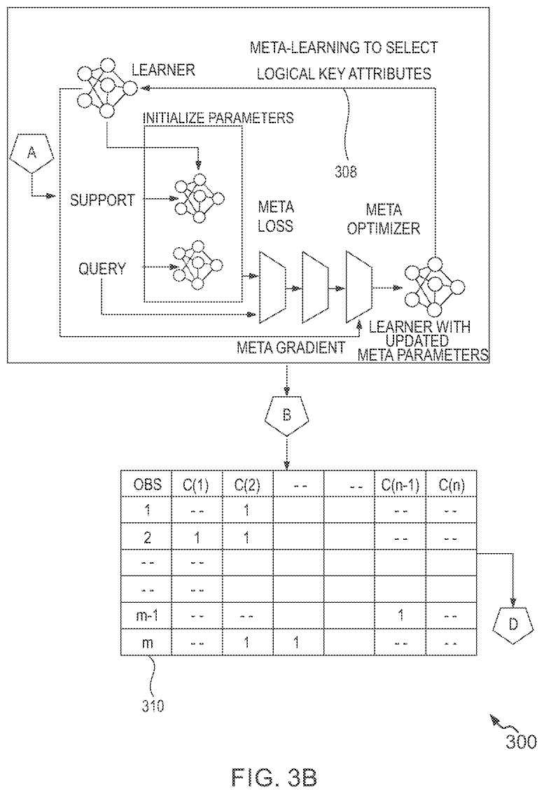

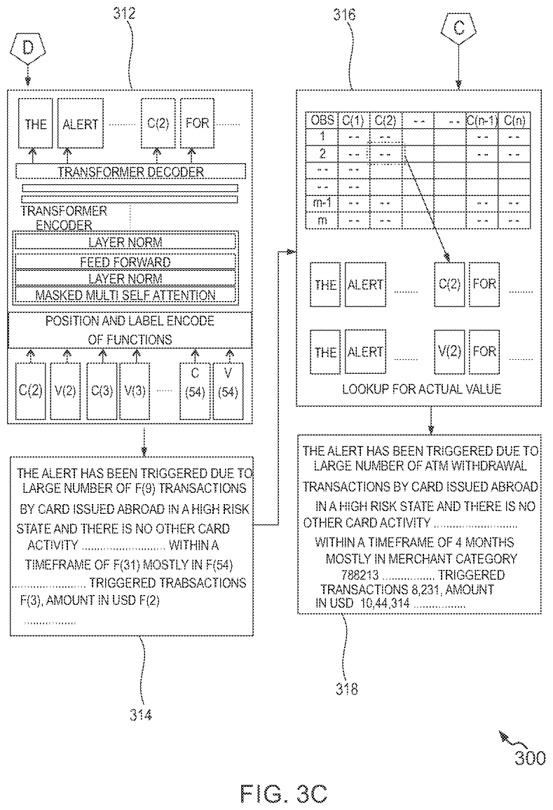

FIGS. 3A, 3B, and 3C, collectively, illustrate a simplified block diagram 300 for generating account-related reports by the server system 200, in accordance with an embodiment of the present disclosure. It is noted that FIGS. 3A-C can be compiled into a singular figure by combining the FIGS. 3A-C at the various connectors as shown (see, A, B, C, and D).

In an embodiment, the server system 200 is configured to access the one or more rule generator file(s) 234 and historical transaction data 302 (it is noted that the historical transaction data 302 is identical to the historical training data 232 of FIG. 2) corresponding to an account holder such as the account holder 104 from a database 204 associated with the server system 200. Then, the server system 200 splits the accessed one or more rule generator file 234 and the historical transaction data 302 into a training dataset 304 and a testing dataset 306.

As may be understood, the training dataset 304 (or meta-training dataset) is the subset of the historical transaction data 302 used to train the various machine learning models (i.e., the first machine learning model 228 and the second machine model 230). Further, the testing dataset 306 (or meta-test dataset) is the subset of the historical transaction data 302 used to test the trained models. In practice, the training dataset 304 and the testing dataset 306 can be collected from the same source(s) at the same time. Thus, for the purposes of this illustrative example, the training dataset 304 and the testing dataset 306 are sourced from a division of the historical transaction data 302 and stored in the database 204 for training and testing the machine learning models.

Optionally, the training dataset 304 and the testing dataset 306 can be preprocessed by the server system 200 collectively through the data pre-processing module 220 and the feature generation module 222. This pre-processing is done to allow the machine learning models to be applied most advantageously toward extraction of the knowledge inherent to the training dataset 304.

During this pre-processing stage a variety of different data transformations can be performed on the dataset to enhance its usefulness by transforming the subset of historical transaction data 302 (i.e., the training dataset 304) into the transaction feature dataset then the transaction feature dataset is used as the training dataset 304. In particular, the machine learning model is trained using the training dataset 304, the machine learning model is trained by adjusting its operating parameters until a desirable training output is achieved. The determination of whether a training output is desirable may be accomplished by comparing the training output to the known characteristics of the training data. Moreover, each training example is comprised of pairs of train and test data points, called an episode.

Furthermore, the testing dataset 306 also known as a meta-testing dataset is preprocessed in the same manner as the training data set 304. Then, the trained machine learning model is tested using the preprocessed testing dataset 304. A test output of the trained machine learning model may be post-processed to determine if the test output is an optimal solution based on the known outcome of the testing dataset 304. Later, the training dataset 304 is fed into the first machine learning model 308 to select relevant transaction features (or logical key features) from the transaction feature dataset. It is noted that for this illustrative example, the first machine learning model 308 (it is noted that the first machine learning model 308 is identical to first machine learning model 228 of FIG. 2) is assumed to be a meta-learning machine learning model, however, other suitable machine learning model may also be used for performing the embodiments of the present disclosure without departing from the scope of the present disclosure. Further, it is to be noted that the meta-learning machine learning model (or the first machine learning model 228) is trained based on a supervised approach, i.e., prior information is extracted from a set of tasks that allows efficient learning on new tasks.

In one implementation, the first machine learning model 308 is randomly initialized and receives the transaction feature dataset as input. Further, the first machine learning model 308 determines relevant transaction features (or logical key features) as an output. As may be understood, the pre-processing of the training dataset 304 reduces its feature dimensionality by way of feature selection.

Generally, in meta-learning based models, the training data (also called the meta-training data) is composed of train and test examples alternately referred to as the support and query set. The meta-learning model is trained on a variety of tasks and then optimized further for novel tasks. It is known in the prior art that a feature classification problem would ideally set up many classes, with at least a few examples for each. These can then be used as a meta-training set to extract prior information, such that when a new task comes in, the model can perform it more efficiently. At a high level, the meta-learning process has two phases: the meta-learning phase and the adaptation phase. In the meta-learning phase, the model learns an initial set of parameters slowly across tasks. Next, during the adaptation phase, it focuses on the quick acquisition of knowledge to learn task-specific parameters. Therefore, as the learning process takes place at two levels, meta-learning is also known as learning to learn.

Further, in the training phase, the model iterates over datasets of different episodes to improve the learning process. In meta-training, start with the first episode, and the meta-learning model takes the training (support) set and produces a learner (or a model) that will take as input the test (query) set and make predictions on it. The objective of the meta-learning model is based on a loss (for example, cross-entropy) that is derived from the test or query data set and backpropagating the loss through these errors. The parameters of the meta-learner (that is, meta-parameters) are then updated based on these errors to optimize the loss. In the next step, the model looks at the next episode where the next episode is trained on the support data set and makes predictions on the query set. Later, the meta-parameters of meta-learners get updated, and then the process may repeat for other episodes. It is understood that by utilizing the present the first machine learning model 308 (i.e., the meta-learning model) there is no need to retrain the model if new relevant transaction features are introduced as inputs, i.e., the present model is resistant to generalization and there is no need to retrain the entire model if new features are introduced. In other words, this model only needs to be trained for newly introduced features while eliminating the need to retrain the model for all features. For example, if a business wants to include a new feature such as “transactions happened between 3 am to 6 am in India” in the account-related summary. The meta-learning model can simply be trained from the additional new feature. In other words, the pre-existing model can be optimized directly for the new feature without retraining the entire model again.

Furthermore, the output of the first machine learning model 308 is the set of relevant and logical features 310 which are further fed into the second machine learning model 312 (it is noted that the second machine model 312 is identical to the second machine learning model 230 of FIG. 2) for generating the structured report template 314 based, at least in part, on the subset of relevant transaction features. In a non-limiting example, the second machine learning model 312 is a language model.

As depicted in FIGS. 3A, 3B and 3C, the structured report template 314 includes the selected set of relevant transaction features. In other words, the structured template report includes a plurality of natural language sentences embedded with the subset of relevant transaction features. As may be understood, the structured report template 314 facilitates the natural language summarization of tabular data in conversational strings. To that end, the structured report template 314 serves as a concise summary with relevant transaction features that give users the information that helps to further explore the table's content.

In a non-limiting implementation, the second machine learning model 312 is a transformer-based large language model (as shown in FIGS. 3A, 3B and 3C). The transformer-based large language model uses a transformer architecture to perform various natural language processing tasks such as summarization of tabular data in conversational strings. As shown in FIGS. 3A, 3B and 3C, the second machine learning model 312 consists of a transformer encoder, a transformer decoder, various layers of feed-forward neural networks, and self-attention layers.

In an example, the transformer encoder layer takes the input text as an input and generates a high-dimensional representation of the text as an output. In one implementation, the transformer encoder layer uses a stack of transformer layers to process the input sequence. In an example, the transformer decoder layer generates an output sequence by decoding the high-dimensional representation generated by the encoder. In one implementation, the transformer decoder layer also uses a stack of transformer layers to generate the output sequence. In an example, the self-attention layer (otherwise known as attention mechanism and depicted as masked multi self-attention in FIGS. 3A, 3B and 3C) is a key component of the transformer-based text generation model (i.e., the second machine learning model 312) and its goal is to attend to different parts of the input sequence and generate context-aware representations. In an implementation, the self-attention layer allows the second machine learning model 312 to focus on the most relevant parts of the input sequence and generate more accurate representations. In an example, the feed-forward layer is a neural network layer that applies a non-linear transformation to input tokens and it is used to transform the context-aware representations generated by the attention mechanism into a final output sequence. In various implementations, normalization layers (depicted as layer norm) can also be added as required to normalize the distributions of intermediate layers thereby, enabling smoother gradients, faster training, and better generalization accuracy. It is understood that the combination of the various layers in the second machine learning model 312 allows the model to learn complex relationships within text data and generate coherent text with high efficiency.

In one implementation, structured report template 314 is fed to a Lookup function 316 which looks for the actual value of the selected set of relevant transaction features in a single row, column, or sentence. Thereafter, the Lookup function 316 finds a value from where the actual value is located, i.e., the historical transaction data 302. Then, the lookup function 316 looks for the position of relevant transaction features in the structured template report 314 and replaces the relevant transaction features with the corresponding values to generate a final account-related summary 318. The final account-related summary 318 contains the actual value of relevant transaction features which minimizes factual errors. The final account-related summary 318 is the summary or narrative of suspicious accounts.

For instance, structured template report 314 may contain a summary with a feature label such as “the alert has been triggered due to a large number of f(9) transactions by card issued abroad in a high-risk state”. Whereas, the final account-related summary 318 may contain the corresponding value of feature f(9) such as “the alert has been triggered due to a large number of ATM withdrawal transactions by card issued abroad in a high-risk state”.

In a non-limiting example, a pseudo-code for generating an account-related report in accordance with the few of the embodiments of the present disclosure is provided below:

| | |
|---|---|
| 1. | Algorithm: Input: T: Tabular data with Mt rows and Ct |

columns. Ct corresponds to the total number of attributes that are
available for each Rt potential risky accounts. : learning rates;

| | |
|---|---|
| 2. | Output: S: Final Automated Report; |
| 3. | Randomly initialize Meta-Learner; |
| 4. | Define an Episode: A episode is defined as the probability |

that Ci ~ Ct should be included in the summary;

| | |
|---|---|
| 5. | Sample a batch of episodes from the meta training dataset; |
| 6. | Initialize the adapter with the learner's parameters; |
| 7. | while number of inner training steps ≠ 0 do |
| | Train the adapter based on the support set(s) of the batch, |
| | compute the loss and the gradients, and update the |
| | adapter's parameter |
| | end while; |
| 8. | Use the updated parameters of the adapter to compute the |

“meta-loss” based on the query set(s) of the batch;

| | |
|---|---|
| 9. | repeat Step 5 to Step 8 for all the episodes of the |

meta-training dataset (or for a certain number of epochs) until the learner
converges to a good set of “meta- parameters” ;

| | |
|---|---|
| 10. | Compute the “meta-gradients”, followed by the “meta-parameters” |

based on the “meta loss, ” and update the learner's parameters;

| | |
|---|---|
| 11. | for every potential risky account do |
| | if P(Ct) > threshold then |
| | filter for logical key attributes |
| | end if |
| | end for |
| | Label encode the attributes |
| 12. | Annotate the actual report to replace the numbers and facts |

coming from the attributes with the label encoding of the attributes;

| | |
|---|---|
| 13. | Train the transformer (Natural language generator) to |

generate the automated report; and

| | |
|---|---|
| 14. | Map the functions with the actual value from the actual |
| | table. |

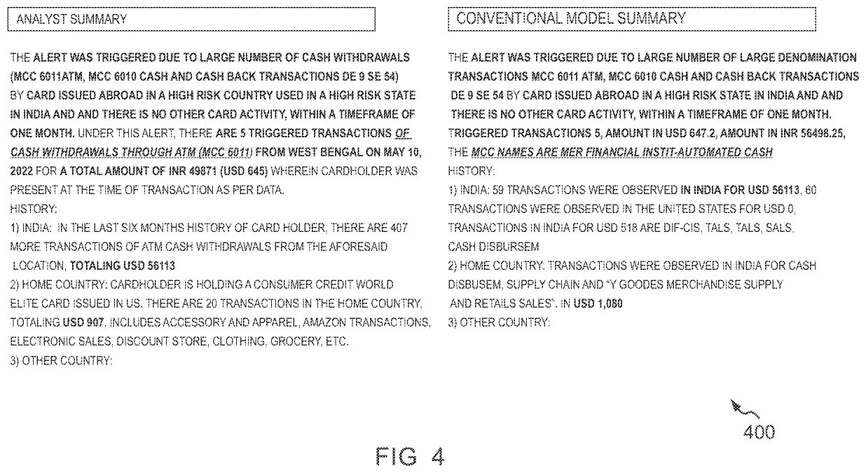

FIG. 4 illustrates a simplified example representation 400 of an account-related summary generated by an analyst (i.e., a human) and a conventional machine learning model, in accordance with an embodiment of the present disclosure.

As may be understood, an account-related summary generated by a human analyst is treated as a benchmark. This is done because human analysts are adept at understanding the underlying relationship/patterns between the plurality of historical transactions performed by an account holder (such as the account holder 104). An analyst can be defined as a human who has received training in perceiving the nuances of suspicious activities performed by the account holder 104 to generate account-related summaries. As depicted in the illustrated example of the account-related summary 318 in FIG. 4, the analyst summary narrates transaction features such as, but not limited to, a reason for alert generation, for which location the alert was generated (e.g. West Bengal), a date of transaction for which the alert is generated (e.g. May 10, 2022), an amount of the transaction (e.g. USD 645), transaction history, a transaction amount for the transaction history (e.g., USD 907) and the like.

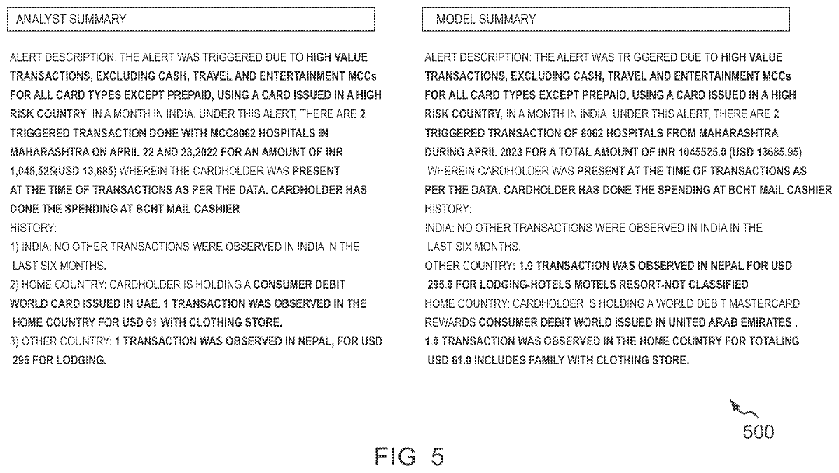

As may be understood, since the analyst is human, the summaries generated by them are susceptible to human errors, and further, the process of summary generation itself is a very time taking process. Therefore, in order to replicate the success of agents in generating account-related summaries, various machine-learning models have been conventionally developed. One such popular model is Generative Pre-trained Transformer (GPT) model. However, these conventional machine learning models face various issues while generating the account-related summaries. One such issue is a lack of accuracy in the generated summaries. As depicted in the illustrated example of an account-related summary in FIG. 4, the conventional model summary narrates incorrect transaction features such as, but not limited to, the reason for alert generation, for which location the alert was generated (e.g. West Bengal) is missing, an incorrect amount of the transaction (e.g., USD 647.2 instead of USD 645), transaction history, incorrect transaction amount for the transaction history (e.g., USD 1080 instead of USD 907) and the like. This is also known as a factual hallucination as the model is generating values on its own that are incorrect, i.e., the model is hallucinating. Since there is a lack of accuracy in the account-related summaries generated by the conventional model, the summaries thus generated still require assistance from an analyst to review and rectify these mistakes. However, this lack of accuracy in the account-related summaries is addressed by the currently presented technical approach utilizing the first machine learning model 228 and the second machine learning 230) by the server system 200 to generate the account-related summaries. The same has been described in reference to FIG. 5.

FIG. 5 illustrates a simplified example representation 500 of an account-related summary generated by the analyst (i.e., a human) and the server system 200, in accordance with an example embodiment of the present disclosure. It is noted that the analyst summary has already been described previously with reference to FIG. 4, therefore, an explanation for the same is not provided again for the sake of brevity.

As depicted by FIG. 5, the account-related summary generated by the server system 200 is accurate and there exist no incorrect transaction features within the generated summary. Further, as may be understood, the summary generated by the server system 200 provides more granular information regarding the reasons for the alerts. This takes place to the use of historical transaction data 232 by the server system 200 to extract relevant transaction features using the meta-learning based first machine learning model 228. This aspect allows the first machine learning model 228 to understand and determine the hidden relationships between different transactions that may not be readily apparent to even human analysts. Therefore, the account-related summaries generated by the server system 200 provide improved insights over the conventional summaries generated by agents while being accurate as well.

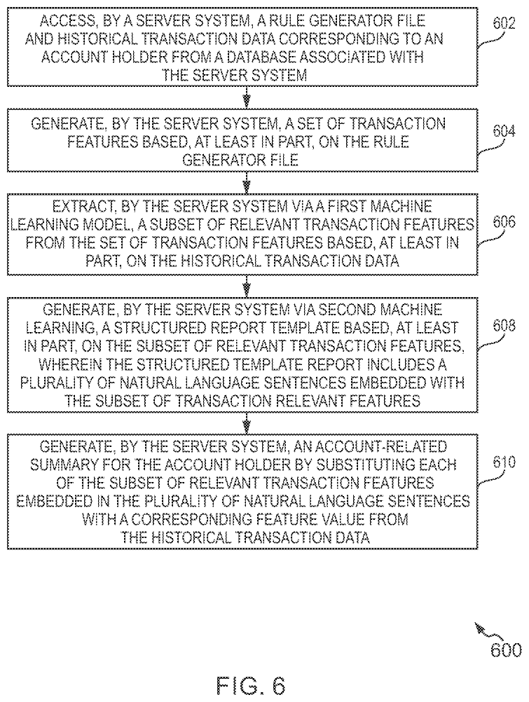

FIG. 6 illustrates a method 600 for generating account-related summary for an account holder 104, in accordance with an embodiment of the present disclosure. The sequence of operations of the method 600 may not be necessarily executed in the same order as they are presented. Further, one or more operations may be grouped together and performed in form of a single step, or one operation may have several sub-steps that may be performed in parallel or in a sequential manner. It is noted that the operations of the method 600, and combinations of operations in the method 600, may be implemented by, for example, hardware, firmware, a processor, circuitry and/or a different device associated with the execution of software that includes one or more computer program instructions. The method 600 starts at operation 602.

At 602, the method 600 includes accessing, by a server system 200, a rule generator file and historical transaction data corresponding to an account holder 104 from a database 204 associated with the server system 200.

At 604, the method 600 includes generating, by the server system 200, a set of transaction features based, at least in part, on the rule generator file 234.

At 606, the method 600 includes extracting, by the server system 200 via a first machine learning model 228, a subset of relevant transaction features from the set of transaction features based, at least in part, on the historical transaction data 232.

At 608, the method 600 includes generating, by the server system 200 via second machine learning 230, a structured report template based, at least in part, on the subset of relevant transaction features, wherein the structured template report includes a plurality of natural language sentences embedded with the subset of relevant transaction features.

At 610, the method 600 includes generating, by the server system 200, an account-related summary for the account holder by substituting each of the subset of relevant transaction features embedded in the plurality of natural language sentences with a corresponding feature value from the historical transaction data 232.

The sequence of operations of the method 600 need not be necessarily executed in the same order as they are presented. Further, one or more operations may be grouped together and performed in form of a single step, or one operation may have several sub-steps that may be performed in parallel or in a sequential manner

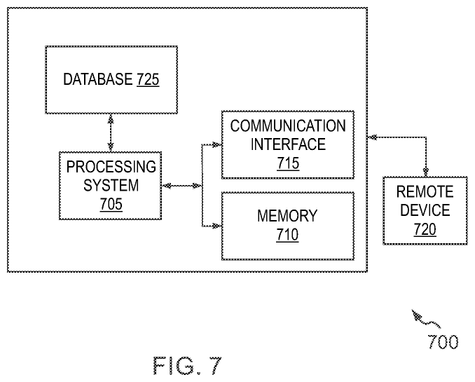

FIG. 7 is a simplified block diagram of a payment server 700, in accordance with an embodiment of the present disclosure. The payment server 700 is an example of the payment server 114 of FIG. 1. The payment server 700 and the server system 200 may use the payment network 112 as a payment interchange network. Examples of payment interchange networks include, but are not limited to, Mastercard® payment system interchange network.

The payment server 700 includes a processing system 705 configured to extract programming instructions from a memory 710 to provide various features of the present disclosure. The components of the payment server 700 provided herein may not be exhaustive and the payment server 700 may include more or fewer components than that depicted in FIG. 7. Further, two or more components may be embodied in one single component, and/or one component may be configured using multiple sub-components to achieve the desired functionalities. Some components of the payment server 700 may be configured using hardware elements, software elements, firmware elements, and/or a combination thereof.

Via a communication interface 715, the processing system 705 receives a request from a remote device 720, such as the issuer server 106 or the acquirer server 108. The request may be a request for conducting the payment transaction. The communication may be achieved through API calls, without loss of generality. The payment server 700 includes a database 725. The database 725 also includes transaction processing data such as an issuer ID, a country code, an acquirer ID, and a merchant identifier (MID), among others.

When the payment server 700 receives a payment transaction request from the acquirer server 108 or a payment terminal (e.g., point of sale (POS) device, etc.), the payment server 700 may route the payment transaction request to an issuer server (e.g., the issuer server 106). The database 725 stores transaction identifiers for identifying transaction details such as the transaction amount, payment card details, acquirer account information, transaction records, merchant account information, and the like.

In one example, the acquirer server 108 is configured to send an authorization request message to the payment server 700. The authorization request message includes, but is not limited to, the payment transaction request.

The processing system 705 further sends the payment transaction request to the issuer server 106 for facilitating the payment transactions from the remote device 720. The processing system 705 is further configured to notify the remote device 720 of the transaction status in form of an authorization response message via the communication interface 715. The authorization response message includes, but is not limited to, a payment transaction response received from the issuer server 106. Alternatively, in one embodiment, the processing system 705 is configured to send an authorization response message for declining the payment transaction request, via the communication interface 715, to the acquirer server 108.

The disclosed methods with reference to FIGS. 1 to 6, or one or more operations of the methods 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Webbook, tablet computing device, smartphone, or other mobile computing devices)). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal-oxide-semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 (or the server system 102) and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), compact disc read-only memory (CD-ROM), compact disc recordable (CD-R), compact disc rewritable (CD-R/W), Digital Versatile Disc (DVD), BLU-RAY® Disc (BD), and semiconductor memories (such as mask ROM, programmable ROM (PROM), erasable PROM (EPROM), flash memory, random access memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a rule generator file and historical transaction data corresponding to an account holder from a database associated with the server system;
generating, by the server system, a set of transaction features based, at least in part, on the rule generator file;
extracting, by the server system via a first machine learning model, a subset of relevant transaction features from the set of transaction features based, at least in part, on the historical transaction data;
generating, by the server system via second machine learning, a structured report template based, at least in part, on the subset of relevant transaction features, wherein the structured template report comprises a plurality of natural language sentences embedded with the subset of relevant transaction features; and
generating, by the server system, an account-related summary for the account holder by substituting each of the subset of relevant transaction features embedded in the plurality of natural language sentences with a corresponding feature value from the historical transaction data.

2. The computer-implemented method as claimed in claim 1, further comprising:
generating, by the server system, one or more alerts corresponding to one or more transactions performed by the account holder based, at least in part, on the historical transaction data and a plurality of predefined rules, the one or more alerts indicating a reason for triggering an alert.

3. The computer-implemented method as claimed in claim 2, further comprising:
generating, by the server system, the rule generator file based, at least in part, on the one or more alerts, the rule generator file comprising a plurality of data fields, the plurality of data fields comprising at least alert time, alert month, alert day, alert rule, transaction identifier (ID), issuer name, acquirer name, alert driver, and account-related summary.

4. The computer-implemented method as claimed in claim 3, further comprising:
generating, by the server system, an account-related report by populating the account-related summary field of the rule generator file with the account-related summary for the account holder; and
transmitting, by the server system, the account-related report to an external server.

5. The computer-implemented method as claimed in claim 1, wherein substituting each of the subset of relevant transaction features, further comprises:
determining, by the server system, one or more corresponding feature values of each of the subset of relevant transaction features embedded in the plurality of natural language sentences based, at least in part, on extracting transaction-related information from the historical transaction data; and
computing, by the server system, the corresponding feature value based, at least in part, on the extracted transaction-related information.

6. The computer-implemented method as claimed in claim 1, wherein the historical transaction data comprises transaction-related information, the transaction-related information comprising at least a date of a payment transaction, an amount of payment transaction, and a number of domestic/international transactions that took place in the past 3/6/12 months with same or different merchants, and Merchant category codes (MCCs).

7. The computer-implemented method as claimed in claim 1, wherein the first machine-learning model is a meta-learning model.

8. The computer-implemented method as claimed in claim 1, wherein the second machine-learning model is a language model.

9. The computer-implemented method as claimed in claim 1, wherein the server system is a payment server associated with a payment network.

10. A server system, comprising:
a memory configured to store instructions;
a communication interface; and
a processor in communication with the memory and the communication interface, the processor configured to execute the instructions stored in the memory and thereby cause the server system to perform, at least in part, to:
access a rule generator file and historical transaction data corresponding to an account holder from a database associated with the server system;
generate a set of transaction features based, at least in part, on the rule generator file;
extract via a first machine learning model, a subset of relevant transaction features from the set of transaction features based, at least in part, on the historical transaction data;
generate via second machine learning, a structured report template based, at least in part, on the subset of relevant transaction features, wherein the structured template report comprises a plurality of natural language sentences embedded with the subset of relevant transaction features; and
generate an account-related summary for the account holder by substituting each of the subset of relevant transaction features embedded in the plurality of natural language sentences with a corresponding feature value from the historical transaction data.

11. The server system as claimed in claim 10, wherein the server system is further caused, at least in part, to:
generate one or more alerts corresponding to one or more transactions performed by the account holder based, at least in part, on the historical transaction data and a plurality of predefined rules, the one or more alerts indicating a reason for triggering an alert.

12. The server system as claimed in claim 11, wherein the server system is further caused, at least in part, to:
generate the rule generator file based, at least in part, on the one or more alerts, the rule generator file comprising a plurality of data fields, the plurality of data fields comprising at least alert time, alert month, alert day, alert rule, transaction identifier (ID), issuer name, acquirer name, alert driver, and account-related summary.

13. The server system as claimed in claim 12, wherein the server system is further caused, at least in part, to:
generate an account-related report by populating the account-related summary field of the rule generator file with the account-related summary for the account holder; and
transmit the account-related report to an external server.

14. The server system as claimed in claim 10, wherein for substituting each of the subset of relevant transaction feature, the server system is further caused, at least in part, to:
determine one or more corresponding feature values of each of the subset of relevant transaction features embedded in the plurality of natural language sentences based, at least in part, on extracting transaction-related information from the historical transaction data; and
compute the corresponding feature value based, at least in part, on the extracted transaction-related information.

15. The server system as claimed in claim 10, wherein the historical transaction data comprises transaction-related information, the transaction-related information comprising at least a date of a payment transaction, an amount of payment transaction, and a number of domestic/international transactions that took place in the past 3/6/12 months with same or different merchants, and Merchant category codes (MCCs).

16. The server system as claimed in claim 10, wherein the first machine-learning model is a meta-learning model and the second machine-learning model is a language model.

17. A non-transitory computer-readable storage medium comprising computer-executable instructions that, when executed by at least a processor of a server system, cause the server system to perform a method comprising:
accessing a rule generator file and historical transaction data corresponding to an account holder from a database associated with the server system;
generating a set of transaction features based, at least in part, on the rule generator file;
extracting via a first machine learning model, a subset of relevant transaction features from the set of transaction features based, at least in part, on the historical transaction data;
generating via second machine learning, a structured report template based, at least in part, on the subset of relevant transaction features, wherein the structured template report comprises a plurality of natural language sentences embedded with the subset of relevant transaction features; and
generating an account-related summary for the account holder by substituting each of the subset of relevant transaction features embedded in the plurality of natural language sentences with a corresponding feature value from the historical transaction data.

18. The non-transitory computer-readable storage medium as claimed in claim 17, further the method comprising:
generating one or more alerts corresponding to one or more transactions performed by the account holder based, at least in part, on the historical transaction data and a plurality of predefined rules, the one or more alerts indicating a reason for triggering an alert.

19. The non-transitory computer-readable storage medium as claimed in claim 18, further the method comprising:
generating the rule generator file based, at least in part, on the one or more alerts, the rule generator file comprising a plurality of data fields, the plurality of data fields comprising at least alert time, alert month, alert day, alert rule, transaction identifier (ID), issuer name, acquirer name, alert driver, and account-related summary.

20. The non-transitory computer-readable storage medium as claimed in claim 19, further the method comprising:
generating an account-related report by populating the account-related summary field of the rule generator file with the account-related summary for the account holder; and
transmitting the account-related report to an external server.
